(19) United States
(12) Patent Application Publication
(10) Pub. No.: US 2022/0267182 A1
(43) Pub. Date: Aug. 25, 2022

(54) EXTERNAL MICRO-INTERFACE PAPERMAKING WASTEWATER TREATMENT SYSTEM AND WASTEWATER TREATMENT METHOD THEREOF

(71) Applicant: NANJING YANCHANG REACTION TECHNOLOGY RESEARCH INSTITUTE CO., LTD., Nanjing (CN)

(72) Inventors: Zhibing ZHANG, Nanjing (CN); Zheng ZHOU, Nanjing (CN); Feng ZHANG, Nanjing (CN); Lei LI, Nanjing (CN); Weimin MENG, Nanjing (CN); Baorong WANG, Nanjing (CN); Gaodong YANG, Nanjing (CN); Huaxun LUO, Nanjing (CN); Guoqiang YANG, Nanjing (CN); Hongzhou TIAN, Nanjing (CN); Yu CAO, Nanjing (CN)

(73) Assignee: NANJING YANCHANG REACTION TECHNOLOGY RESEARCH INSTITUTE CO., LTD., Nanjing (CN)

(21) Appl. No.: 17/617,928

(22) PCT Filed: May 27, 2020
(86) PCT No.: PCT/CN2020/092692

§ 371 Date: Dec. 9, 2021

(30) Foreign Application Priority Data
Mar. 24, 2020 (CN) 202010214344.8

(51) Int. Cl. C02F 9/00; C02F 1/00; C02F 1/74; C02F 1/72

(52) U.S. Cl. CPC C02F 9/00; C02F 1/001; C02F 1/74; C02F 1/727; C02F 2303/04; C02F 2001/007; C02F 2103/28

(57) ABSTRACT

An external micro-interface papermaking wastewater treatment system and a wastewater treatment method are proposed. The wastewater treatment system includes a grating water collection tank, a first coagulation sedimentation tank, an inclined screen and a second coagulation sedimentation tank which are connected in sequence, a heat exchanger, a preheater and a wet oxidation reactor, wherein the heat exchanger is provided with a first inlet, a first outlet, a second inlet and a second outlet. A feed inlet is disposed on a side wall of the wet oxidation reactor, an oxidation water outlet is disposed on a top of the wet oxidation reactor, the feed inlet is connected with a micro-interface generator for dispersing and breaking gas into gas bubbles, a liquid phase inlet and a gas phase inlet are disposed on the micro-interface generator, and the gas phase inlet is connected with an air compressor.

### TECHNICAL FILED

The invention relates to the technical field of a papermaking wastewater treatment, in particular, to an external micro-interface papermaking wastewater treatment system and a wastewater treatment method thereof.

### BACKGROUND OF THE APPLICATION

At present, wastewater discharged from the paper industry in China accounts for about 15% of the total discharge amount of industrial wastewater in China, and the discharge amount of COD accounts for more than ⅓ of the total discharge amount of the industrial COD in China. Papermaking wastewater has a large discharge capacity, a large alkalinity, a high content of difficult degradation substances, and large oxygen consumption, resulting in water pollution and serious damage to the ecological environment. Therefore, how to apply papermaking wastewater treatment technology, turn harm into benefit, recycle resources, and promote ecological environment protection and sustainable development of papermaking industry has important practical significance.

Due to the complex composition and high temperature of wastewater, the wastewater treatment process in combination with physical method, chemical method and biochemical method is adopted in industry. At present, wet oxidation technology has been successful in treating papermaking wastewater by combining with other processes because of its strong adaptability and good treatment effect. However, the wet oxidation method requires a relatively high reaction temperature, pressure and a relatively long residence time, and the reasons are that air or oxygen in a liquid phase has a short residence time, a short mass transfer time, a large bubble diameter, a relatively small gas-liquid phase interface area formed in a reactor, and a short mass transfer space, resulting in problems of a long reaction time, high energy consumption, and low reaction efficiency.

In view of this, the present invention is proposed.

### SUMMARY

A first objective of the present invention is to provide an external micro-interface papermaking wastewater treatment system. In the wastewater treatment system, a micro-interface generator is disposed in front of a wet oxidation reactor, thereby improving mass transfer effect and the reaction efficiency between two phases. Bubbles can be broken into micron-scale bubbles, thereby increasing the interfacial area between a gas phase and a liquid phase, fully filling the mass transfer space, increasing the residence time of air or oxygen in the liquid phase, and reducing the consumption of air or oxygen. In this way, even if high temperature and high pressure are not required, the reaction itself can also be ensured to proceed efficiently, avoiding a series of potential safety hazards caused by high temperature and high pressure, facilitating the energy saving and the consumption of the reaction process, and having the low cost.

In order to achieve the above objectives of the present invention, the following technical schemes are specially adopted.

The present invention provides an external micro-interface papermaking wastewater treatment system, including a grating water collection tank, a first coagulation sedimentation tank, an inclined screen and a second coagulation sedimentation tank which are connected in sequence, a heat exchanger, a preheater and a wet oxidation reactor, wherein the heat exchanger is provided with a first inlet, a first outlet, a second inlet and a second outlet. A feed inlet is disposed on a side wall of the wet oxidation reactor, an oxidation water outlet is disposed on a top of the wet oxidation reactor, the feed inlet is connected with a micro-interface generator for dispersing and breaking gas into gas bubbles, a liquid phase inlet and a gas phase inlet are disposed on the micro-interface generator, and the gas phase inlet is connected with an air compressor. The first inlet is in communication with the second coagulation sedimentation tank, the first outlet is in communication with the liquid phase inlet of the micro-interface generator through the preheater, the second inlet is in communication with the oxidation water outlet, and the second outlet is connected with an aeration biological filtration tank.

In the papermaking wastewater treatment process in the prior art, the wet oxidation treatment method often requires a higher reaction temperature, a higher reaction pressure, and a longer residence time. The reason is that the residence time of air or oxygen in the liquid phase is short, the mass transfer time is insufficient, the bubble diameter is large, the gas-liquid phase boundary area formed in the reactor is small, and the mass transfer space is insufficient, which leads to problems of an excessively long reaction time, high energy consumption, and low reaction efficiency.

In the above-described wastewater treatment system, certain pretreatments must be performed before the wet oxidation treatment. The wastewater treatment system includes a grating water collection tank, a first coagulation sedimentation tank, an inclined screen and a second coagulation sedimentation tank which are connected in sequence. The wastewater discharged from the papermaking process first enters the grating water collection tank. The grating water collection tank is provided with a mechanical grid, preferably a rotary mechanical grid, which is more effective than other grids to continuously and automatically remove large-size floating and suspended substances. The wastewater from the grating water collection tank then enters the first coagulation sedimentation tank. The SS pollutants flocculate and settle by adding coagulants or coagulants to the wastewater. Further, the first coagulation sedimentation tank is a partition sedimentation tank. The partition sedimentation tank has good flocculation effect and low cost. The wastewater treated by the first coagulation sedimentation tank then enters the inclined screen, which is used to recycle fibers in the wastewater. The filter mesh of the inclined screen is preferably composed of 80 mesh and 100 mesh nylon filters, such that long fibers can be recycled. The wastewater treated by the inclined screen then enters the second coagulation sedimentation tank.

After the wastewater undergoes preliminary pretreatments such as impurity removal and sedimentation in the above-mentioned wastewater treatment system, subsequent wet oxidation treatment is carried out to achieve a deeper wastewater purification effect.

It should be noted that, by disposing a micro-interface unit in front of a wet oxidation reactor of the wastewater treatment system, air or oxygen that enters the wet oxidation reactor is broken and dispersed into gas bubbles, which enables the gas bubbles and wastewater to form a gas-liquid emulsion, thereby increasing an interfacial area between the gas and the wastewater, and further increasing reaction efficiency. After the mass transfer effect of a reaction phase interface is increased, a high operation temperature and a high operation pressure are not required, which achieves the effects of low energy consumption and low operation cost.

The micro-interface unit of the present invention includes a pneumatic micro-interface generator, so that air or oxygen compressed by an air compressor enters from an air inlet to an interior of the pneumatic micro-interface generator. Through the breaking and dispersing function of the micro-interface generator, the gas is dispersed and broken into micro gas bubbles, thereby reducing the thickness of a liquid film, effectively increasing the mass transfer area between the air or oxygen and wastewater, reducing mass transfer resistance, and improving the reaction efficiency.

Further, the setting mode, the setting position, and the number of the micro-interface generators contained in the micro-interface unit are not limited. More preferably, the number of the micro-interface generators is more than one, and the micro-interface generators are arranged in parallel from top to bottom before the wet oxidation reactor. Through arranging the micro-interface generators in parallel in multiple rows, the incoming materials can be dispersed and crushed at the same time, and the subsequent reaction efficiency can be effectively improved.

A person skilled in the art would understand that the micro-interface generator used in the present invention is embodied in the prior patent of the present invention. For example, in a CN patent with a publication no. 106215730 A, the core of the micro-interface generator is gas bubble crushing. The principle of a bubble breaker is that the gas carried by high-speed jet collides with each other for energy transfer, so as to break up the gas bubbles. One embodiment of the structure of the micro-interface generator is disclosed in the above-described patent, and will not be repeated redundantly herein. The connection between the micro-interface generator and the wet oxidation reactor, including a connection structure and a connection position, is determined according to the structure of the micro-interface generator, and is not limited herein. The reaction mechanism and control method for the micro-interface generator are disclosed in the inventor's prior patent CN 107563051 B, and will not be repeated redundantly herein.

Further, the wastewater treatment system further includes a sludge tank connected to both the first coagulation sedimentation tank and the second coagulation sedimentation tank. Preferably, the sludge tank is connected to a sludge dewatering machine, and the sludge is buried or reused after being dewatered.

Further, the first coagulation sedimentation tank is composed of two or more coagulation sedimentation tanks connected in series; and the second coagulation sedimentation tank is composed of two or more coagulation sedimentation tanks connected in series. The use of multi-stage coagulation sedimentation can effectively remove pollutants such as SS, BOD and COD.

Further, the second coagulation sedimentation tank includes three filter layers arranged from top to bottom, and each filter layer is filled with a flocculating substance. Preferably, the second coagulation sedimentation tank is a vortex sedimentation tank, which has advantages of short flocculation time good flocculation effect, and large capacity compared with other coagulation sedimentation tanks.

Further, the wastewater treatment system further includes an ion exchanger, and the ion exchanger is connected to the aeration biological filtration tank for neutralizing alkalis in wastewater. The strongly-acidic cation exchange resin in the ion exchanger can neutralize the alkali contained in the wastewater, and can also remove pollutants such as BOD and COD, which can further reduce the content of organic pollutants in the wastewater. The ion exchanger is a fixed bed ion exchanger or a continuous ion exchanger.

Further, the wastewater treatment system further includes a COD concentration monitoring device and a disinfection tank, wherein the COD concentration monitoring device is connected to the ion exchanger for monitoring a water quality and discharging a qualified water into the disinfection tank, and the COD concentration monitoring device is connected with the aeration biological filtration pond for returning an unqualified water into the aeration biological filtration tank for further treatment. Through COD concentration detection, whether the wastewater treatment indicators meet the requirements can be detected in time, and the entire wastewater treatment system can be monitored at the same time to facilitate timely maintenance. The disinfection tank can be disinfected by ultraviolet or ozone.

Further, a first solenoid valve is disposed on a first connection pipeline between the COD concentration monitoring device and the disinfection tank, and a second solenoid valve is disposed on a second connection pipeline between the COD concentration monitoring device and the aeration biological filter tank. The clean water treated after ion exchange then enters the COD concentration monitoring device to monitor the COD concentration of the water. If the COD concentration of the clean water is lower than a pre-set value, it meets requirements and can be recycled. The first solenoid valve is turned on, such that the clean water enters the clean water tank. If the COD concentration of the clean water is higher than the pre-set value, the second solenoid valve is turned on, and the clean water returns to the aeration biological filter tank through the pipeline for biological purification again.

Further, a booster pump is provided between the coagulation sedimentation tank and the heat exchanger. A pressure monitoring module and a control module are also provided inside the booster pump. During the process, if the pressure is monitored to be excessively high or excessively low, the control module can turn on or turn off the booster pump at any time. The booster pump can also be connected in series or in parallel to implement multi-stage boosting, and the multi-stage boosting can be used for adjusting the pressure according to actual needs.

Further, the present invention also provides a wastewater treatment method by adopting the above-mentioned wastewater treatment system. The method includes the following steps:

a wastewater first enters the grating water collection tank to remove large-scale floating and suspended matters, and then enters the first coagulation sedimentation tank to flocculate and settle SS pollutants in the wastewater; the wastewater settled by the first coagulation settling enters the inclined screen to recover fibers in the wastewater; the wastewater passing through the inclined screen then enters the second coagulation sedimentation tank for treatment; and

the wastewater treated in the described steps is heated and then enters the micro-interface generator, and compressed air or oxygen is introduced into the micro-interface generator at the same time, and after dispersed and broken micro-bubbles and the wastewater are fully emulsified in the micro-interface generator, and then enters the wet oxidation reactor for wet oxidation treatment; and a product after wet oxidation treatment enters the aeration biological filtration tank for biological oxidation treatment after heat exchange and cooling.

Preferably, the reaction temperature of the wet oxidation treatment is 170-180° C., and a reaction pressure is 3-3.5 MPa. Or the reaction temperature is 175° C., and the reaction pressure is 3.2 MPa.

The wastewater treatment method of the present invention is easy to operate, has mild operation conditions, and has low energy consumption, and achieves a better treatment effect compared with the prior art.

Compared with the prior art, the present invention has the following beneficial effects:

(1) a micro-interface generator is provided before a wet oxidation reactor, thereby improving the mass transfer effect and the reaction efficiency between two phases; bubbles can be broken into micron-scale bubbles, thereby increasing the interfacial area between a gas phase and a liquid phase, fully filling the mass transfer space, increasing the residence time of air or oxygen in the liquid phase, and reducing the consumption of air or oxygen; in this way, even if the temperature and pressure do not need to be too high, the reaction itself can also be ensured to proceed efficiently, avoiding a series of potential safety hazards caused by high temperature and high pressure, facilitating the energy saving and the consumption of the reaction process, and having the low cost.

(2) The present invention also significantly reduces the energy consumption of the air compressor by reducing the reaction temperature and pressure. During the wet oxidation process, the oxidation of the organic substance generates a large amount of heat, which can basically maintain the self-supply of heat during the operation of the device. Its operational cost is primarily the energy consumption of the air compressor and pump, of which the air compressor accounts for the majority of the energy consumption. The outlet pressure of the compressor is reduced, thereby significantly reducing the energy consumption of the compressor, and reducing costs for enterprises.

### BRIEF DESCRIPTION OF DRAWINGS

By reading the detailed description of the preferred embodiments below, various other advantages and benefits will become clear to those of ordinary skill in the art. The drawings are only used for the purpose of illustrating the preferred embodiments, and are not considered as a limitation to the invention. Also, throughout the drawings, the same reference numerals are used to denote the same components. In the drawings:

FIG. 1 is a structural diagram of an external micro-interface papermaking wastewater treatment system according to an embodiment of the present invention.

### DETAIL DESCRIPTION

In order to make the purpose and advantages of the invention clearer, the invention will be further described below in conjunction with the embodiments. It should be understood that the specific embodiments described here are only used to explain the invention, and are not used to limit the invention.

Based on the embodiments of the present invention, all other embodiments obtained by those of ordinary skill in the art without creative work shall fall within the scope of the present invention. If specific conditions are not indicated in the embodiments, it shall be carried out in accordance with the conventional conditions or the conditions recommended by the manufacturer. The reagents or instruments used without the manufacturer's indication are all conventional products that can be purchased on the market.

It should be understood that in the description of the invention, orientations or position relationships indicated by terms upper, lower, front, back, left, right, inside, outside and the like are orientations or position relationships are based on the direction or position relationship shown in the drawings, which is only for ease of description, rather than indicating or implying that the device or element must have a specific orientation, be constructed and operated in a specific orientation, and therefore cannot be understood as a limitation of the invention. In addition, the terms “first”, “second”, and “third” are only used for descriptive purposes, and cannot be understood as indicating or implying relative importance.

Further, it should also be noted that in the description of the invention, terms “mounting”, “connected” and “connection” should be understood broadly, for example, may be fixed connection and also may be detachable connection or integral connection; may be mechanical connection and also may be electrical connection; and may be direct connection, also may be indirection connection through an intermediary, and also may be communication of interiors of two components. Those skilled in the art may understand the specific meaning of terms in the invention according to specific circumstance.

In order to explain the technical solutions of the present invention more clearly, specific embodiments are used for description below.

### EMBODIMENTS

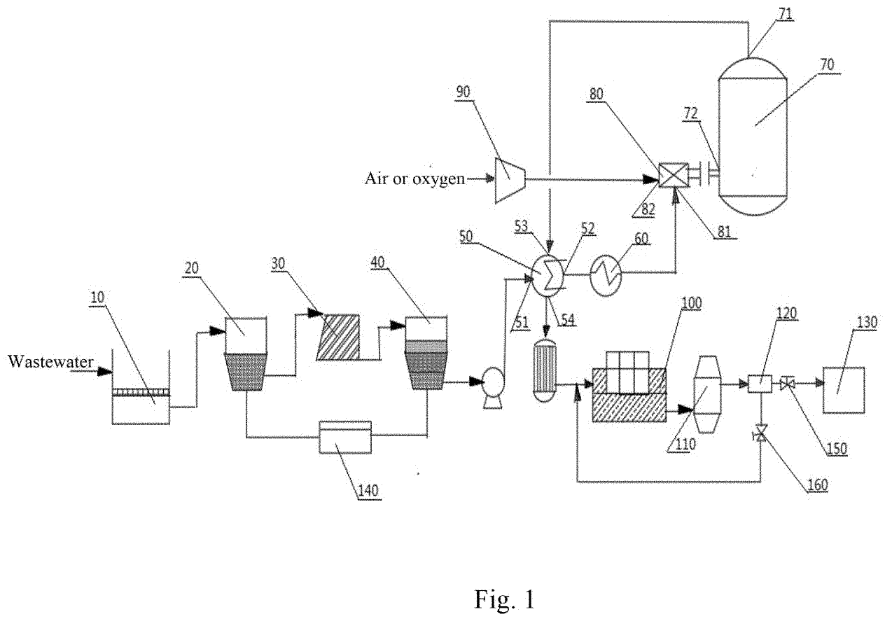

Referring to FIG. 1, an external micro-interface papermaking wastewater treatment system according to an embodiment of the present invention comprises a grating water collection tank 10, a first coagulation sedimentation tank 20, an inclined screen 30 and a second coagulation sedimentation tank 40 which are connected in sequence, a heat exchanger 50, a preheater 60, a wet oxidation reactor 70, and an aeration biological filtration tank 100. A sludge tank 140 is provided at the bottom of the first coagulation sedimentation tank 20 and the second coagulation sedimentation tank 40, and both the first coagulation sedimentation tank 20 and the second coagulation sedimentation tank 40 are connected to the sludge tank 140. A feed inlet 72 is disposed on the side wall of the wet oxidation reactor 70, an oxidation water outlet 71 is disposed on the top of the wet oxidation reactor, the feed inlet 72 is connected with a micro-interface generator 80 for dispersing broken gas into gas bubbles, a liquid phase inlet 81 and a gas phase inlet 82 are disposed on the micro-interface generator 80, and the gas phase inlet 82 is connected with an air compressor 90.

Specifically, after being heat exchanged in the heat exchanger 50 and then being heated by the preheater 60, the wastewater enters the micro-interface generator 80 from the liquid phase inlet 81, and air or oxygen enters the micro-interface generator 80 through the gas-phase inlet 82 after being compressed by the air compressor 90 and is dispersed and broken into bubbles. The air compressor 90 is preferably a centrifugal air compressor, because the centrifugal air compressor has a large amount of air, does not need lubrication inside, saves oil and does not pollute the compressed gas.

The compressed air or oxygen is dispersed into air bubbles, sufficiently emulsified with the wastewater in the micro-interface generator 80, and then enters the wet oxidation reactor 70 for an oxidation reaction, by means of the effect of the micro-interface generator, increasing the contact area of the gas-liquid two phases, and improving the mass transfer effect. It should be understood that the described micro-interface generators 80 is not limited to the number. In order to improve the dispersion and mass transfer effects, additional micro-interface generators can be additionally provided. Multiple micro-interface generators can be provided in series or in parallel before the wet oxidation reactor 70. Preferably, the micro-interface generators are provided in parallel from top to bottom. In this embodiment, the type of the micro-interface generator is a pneumatic micro-interface generator, and compressed air or oxygen is used as a power drive.

The heat exchanger 50 of the embodiment is provided with a first inlet 51, a first outlet 52, a second inlet 53, and a second outlet 54; the second coagulation sedimentation tank 40 is preferably connected to the first inlet 51 through a booster pump. The first outlet 52 is connected to the liquid phase inlet 81 of the micro-interface generator 80 through the pre-heater 60. Before the wastewater passes through the heat exchanger 50 and enters the liquid phase inlet 81, pre-heating is performed. An oxidation water outlet 71 is further disposed at the top of the wet oxidation reactor 70. The oxidation water outlet is connected to the second inlet 53. The oxidation water from the oxidation water outlet 71 enters the heat exchanger 50 through the second inlet 53 for heat exchange. The oxidation water to be treated is heated while being cooled, thereby achieving the purpose of fully utilizing energy. Then, the oxidation water after heat exchange enters the aeration biological filtration tank 100 passing through the second outlet 54. Preferably, a condenser can be added between the second outlet 54 and the aeration biological filtration tank 100, and the oxidation water is cooled before entering the aeration biological filtration tank 100 after heat exchange.

In the present embodiment, the wastewater treatment system further includes an ion exchanger 110, a COD concentration detection device 120 and a disinfection tank 130. The ion exchanger 110 is connected with the aeration biological filtration tank 100 and is used for neutralizing alkali in wastewater. The COD concentration monitoring device 120 is connected with the ion exchanger 110 and is used for monitoring water quality and discharging qualified water into the disinfection tank 130. The COD concentration monitoring device 120 is connected with the aeration biological filtration tank 100. In addition, a first solenoid valve 150 is disposed on a connection pipeline between the COD concentration monitoring device 120 and the disinfection tank 130; and a second solenoid valve 160 is disposed on a connection pipeline between the COD concentration monitoring device 120 and the aeration biological filtration tank 100.

Specifically, the ion exchanged clean water first enters the COD concentration monitoring device 120 for monitoring the concentration of the COD in the water. If the concentration of the COD in the clean water is lower than a pre-set value, the requirements are satisfied, and recycling can be performed. A first solenoid valve 150 is turned on and the water enters a disinfection tank 130 for ultraviolet or ozone disinfection. If the COD concentration of the clean water is higher than the pre-set value, the second solenoid valve is opened, and the water is returned to the aeration biological filtration tank 100 passing through the pipeline for biological purification again.

The working process and principle of the external micro-interface papermaking wastewater treatment system of the present invention are briefly described below: a papermaking wastewater first enters a grating water collection tank 10 to remove large-scale floating and suspended matter, and then enters the first coagulation sedimentation tank 20 to flocculate and settle SS pollutants in the wastewater; the wastewater settled by the first coagulation settling enters the inclined screen 30 to recover fibers in water; the wastewater passing through the inclined screen then enters the second coagulation sedimentation tank 40 for treatment; the wastewater treated in the described steps enters the micro-interface generator 80 after being heated, and compressed air or oxygen is introduced into the micro-interface generator 80, and after dispersed and broken micro-bubbles and wastewater are fully emulsified in the micro-interface generator 80, and then enters the wet oxidation reactor 70 for wet oxidation treatment; and the reaction temperature of the wet oxidation treatment is 170-180° C., and the reaction pressure is 3-3.5 MPa. Preferably the reaction temperature is 175° C., and the reaction pressure is 3.2 MPa. The oxidation product enters the heat exchanger 50 through the oxidation water outlet 71, exchanges heat with the wastewater to be treated, and then enters the aeration biological filtration tank 100 through the cooler for biodegradation treatment. The biodegraded water is neutralized alkali in the wastewater by the ion exchanger 110, and enters the COD concentration detection device 120 for monitoring water quality and discharging qualified water into the disinfection tank 130 for disinfection and recycling.

So far, the technical solution of the invention has been described in conjunction with the preferred embodiments shown in the drawings. However, it is easily understood by those skilled in the art that the protection scope of the invention is obviously not limited to these specific embodiments. Without departing from the principle of the invention, those skilled in the art can make equivalent changes or substitutions to the relevant technical features, which will fall into the protection scope of the invention. The above are only preferred embodiments of the invention rather than limits to the invention. Those skilled in the art may make various modifications and changes to the invention. Any modification, equivalent replacement, improvement and the like made within the spirit and principle of the invention all should be included in the protection scope of the invention.

1. An external micro-interface papermaking wastewater treatment system, comprising a grating water collection tank, a first coagulation sedimentation tank, an inclined screen and a second coagulation sedimentation tank which are connected in sequence, a heat exchanger, a preheater and a wet oxidation reactor, wherein the heat exchanger is provided with a first inlet, a first outlet, a second inlet and a second outlet; a feed inlet is disposed on a side wall of the wet oxidation reactor, an oxidation water outlet is disposed on a top of the wet oxidation reactor, the feed inlet is connected with a micro-interface generator for dispersing and breaking gas into gas bubbles, a liquid phase inlet and a gas phase inlet are disposed on the micro-interface generator, and the gas phase inlet is connected with an air compressor; wherein the micro-interface generator is a pneumatic micro-interface generator, a number of the micro-interface generator is more than one, and the micro-interface generators arranged in parallel from top to bottom;
wherein the first inlet is in communication with the second coagulation sedimentation tank, the first outlet is in communication with the liquid phase inlet of the micro-interface generator through the preheater, the second inlet is in communication with the oxidation water outlet, and the second outlet is connected with an aeration biological filtration tank.

2. (canceled)

3. The external micro-interface papermaking wastewater treatment system according to claim 1, further comprising:
a sludge tank connected to both the first coagulation sedimentation tank and the second coagulation sedimentation tank.

4. The external micro-interface papermaking wastewater treatment system according to claim 1, wherein the first coagulation sedimentation tank is composed of two or more coagulation sedimentation tanks connected in series; and the second coagulation sedimentation tank is composed of two or more coagulation sedimentation tanks connected in series.

5. The external micro-interface papermaking wastewater treatment system according to claim 1, wherein the second coagulation sedimentation tank comprises three filter layers arranged from top to bottom, and each filter layer is filled with a flocculating sub stance.

6. The external micro-interface papermaking wastewater treatment system according to claim 1, further comprising:
an ion exchanger, and the ion exchanger is connected to the aeration biological filtration tank for neutralizing alkalis in wastewater.

7. The external micro-interface papermaking wastewater treatment system according to claim 6, further comprising:
a COD concentration monitoring device and a disinfection tank, wherein the COD concentration monitoring device is connected to the ion exchanger for monitoring a water quality and discharging a qualified water into the disinfection tank, and the COD concentration monitoring device is connected with the aeration biological filtration pond for returning an unqualified water into the aeration biological filtration tank for further treatment.

8. The external micro-interface papermaking wastewater treatment system according to claim 7, wherein a first solenoid valve is disposed on a first connection pipeline between the COD concentration monitoring device and the disinfection tank, and a second solenoid valve is disposed on a second connection pipeline between the COD concentration monitoring device and the aeration biological filter tank.

9. A wastewater treatment method by using the external micro-interface papermaking wastewater treatment system according to claim 1, comprising the following steps:
a wastewater first enters the grating water collection tank to remove large-scale floating and suspended matters, and then enters the first coagulation sedimentation tank to flocculate and settle SS pollutants in the wastewater; the wastewater settled by the first coagulation settling enters the inclined screen to recover fibers in the wastewater; the wastewater passing through the inclined screen then enters the second coagulation sedimentation tank for treatment; and
the wastewater treated in the described steps is heated and then enters the micro-interface generator, and compressed air or oxygen is introduced into the micro-interface generator at the same time, and after dispersed and broken micro-bubbles and the wastewater are fully emulsified in the micro-interface generator, and then enters the wet oxidation reactor for wet oxidation treatment; and a product after wet oxidation treatment enters the aeration biological filtration tank for biological oxidation treatment after heat exchange and cooling.

10. The wastewater treatment method according to claim 9,
wherein a reaction temperature of the wet oxidation treatment is 170-180° C., and a reaction pressure is 3-3.5 MPa.

11. The wastewater treatment method according to claim 10,
wherein the reaction temperature of the wet oxidation treatment is 175° C., and the reaction pressure is 3.2 MPa.
